(19) United States
(12) Patent Application Publication
(10) Pub. No.: US 2011/0232362 A1
(43) Pub. Date: Sep. 29, 2011

(54) DETECTION OF EXHAUST FILTER EFFECTIVENESS

(75) Inventors: Sairam Payyalore Thiagarajan, Dunlap, IL (US); Matthew Edward Leustek, Metamora, IL (US); Trent J. Cleveland, Germantown Hills, IL (US); Dereck G. Heffron, Peoria, IL (US)

(73) Assignee: Caterpillar Inc., Peoria, IL (US)

(21) Appl. No.: 12/729,967

(22) Filed: Mar. 23, 2010

(51) Int. Cl. G01N 7/00

(52) U.S. Cl. 73/23.33

(57) ABSTRACT

A method and kit for determining the effectiveness of an exhaust filter. The method may involve exposing an indicator to an exhaust stream of a engine downstream of the exhaust filter, visually comparing the indicator against test samples, and assigning a level of exhaust filter effectiveness based on the comparison. The method may also involve restricting the exhaust stream, diverting a test stream of exhaust from the exhaust stream, and exposing the indicator to the test stream. The kit may include a collector having a housing defining a flow passage configured to transmit a test stream of exhaust from a engine and a restrictor having a orifice plate configured to restrict an exhaust stream from which the test stream is diverted.

### TECHNICAL FIELD

The present disclosure relates to engine exhaust aftertreatment systems and more particularly to testing of exhaust filters.

### BACKGROUND

Engine exhaust aftertreatment systems may include filters such a diesel particulate filters (DPFs) to trap particulate matter or soot contained in exhaust. These filters may develop cracks or otherwise fail, reducing their effectiveness. Detecting that a filter failure has occurred may be difficult because the filter may not be visible and any change to the exiting exhaust may be difficult to perceive.

U.S. Pat. No. 7,334,401 discloses a sensor for sensing the presence of particulates in a gas flow stream. Such a sensor, however, would be too expensive and not robust enough to use in regular field tests.

### SUMMARY

The present disclosure provides a method for determining the effectiveness of an exhaust filter. In one aspect, the method includes exposing an indicator to an exhaust stream of a engine downstream of the exhaust filter, visually comparing the indicator against test samples, and assigning a level of exhaust filter effectiveness based on the comparison.

In another aspect, the method includes restricting the exhaust stream, diverting a test stream of exhaust from the exhaust stream, and exposing the indicator to the test stream

The present disclosure also provides a kit for determining the effectiveness of an exhaust filter. The kit includes a collector having a housing defining a flow passage configured to transmit a test stream of exhaust from an engine and a restrictor including an orifice plate configured to restrict an exhaust stream from which the test stream is diverted.

### BRIEF DESCRIPTION OF THE DRAWINGS

FIG. 1 is a diagrammatic view of a machine including a power system with an aftertreatment system.

FIG. 2 is a diagrammatic view of the machine from FIG. 1 in a test mode.

FIG. 3 is a diagrammatic view of an alternative embodiment of the machine from FIG. 1 in the test mode.

FIG. 4 is a diagrammatic view of an alternative embodiment of the machine from FIG. 1 in the test mode.

FIG. 5 is a side view of a collector.

FIG. 6 is a cross-sectional side view of the collector from FIG. 5.

FIG. 7 is a top view of an indicator and a grading sheet.

FIG. 8 is a side view of a measurement device used as an alternative to the grading sheet.

FIG. 9 is a flow chart of a testing method.

### DETAILED DESCRIPTION

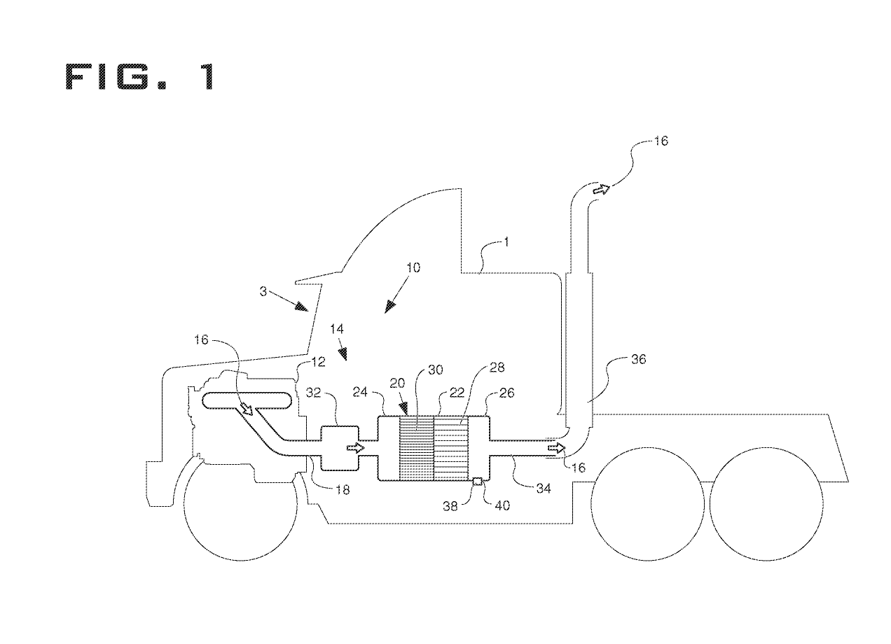

FIG. 1 shows a machine 1 in an operation mode 3. The machine 1 includes a power system 10. The machine 1 is shown as a mobile machine but could be stationary. The machine might be a mobile machine, on-highway truck, car, vehicle, off-highway truck, earth moving equipment, tractor, generator, pump, aerospace application, locomotive application, marine application, or any other device or application requiring a power system 10.

The power system 10 includes an engine 12 and an aftertreatment system 14 to treat an exhaust stream 16 produced by the engine 12. The engine 12 may include other features not shown, such as controllers, fuel systems, air systems, cooling systems, peripheries, drivetrain components, turbochargers, exhaust gas recirculation systems, etc. The engine 12 may be any type of engine (internal combustion, gas, diesel, gaseous fuel, natural gas, propane, etc.), may be of any size, with any number of cylinders, and in any configuration (“V,” in-line, radial, etc.).

The aftertreatment system 14 is configured to remove, collect, or convert undesired constituents from the exhaust stream 16. The aftertreatment system 14 includes an engine exhaust pipe 18 delivering the exhaust stream 16 to an aftertreatment device 20. The aftertreatment device 20 includes a center canister 22, inlet canister 24, and an outlet canister 26. The center canister 22 houses an exhaust filter 28. The inlet canister 24 is upstream of the exhaust filter 28. The outlet canister 26 is downstream of the exhaust filter 28 and may be adjacent to an outlet of the exhaust filter 28.

In one embodiment, where the engine 12 is diesel, the exhaust filter 28 may be a diesel particulate filter (DPF). The exhaust filter 28 is configured to collect particulate matter, soot, ash, or other constituents from the exhaust stream 16. The filtering is often achieved by forcing the exhaust stream 16 to pass through the walls of the exhaust filter 28, leaving the particulate matter behind.

Most exhaust filters 28 are constructed from ceramics such as cordierite, but could also be made from silicone carbide (SiC), metallic fibers, or other materials. The exhaust filters 28 also often have complex honeycomb or other shapes and may have thin walls. Because of the materials and geometries involved, exhaust filters 28 may be susceptible to cracking and damage.

The center canister 22 may also house a diesel oxidation catalyst (DOC) 30. The DOC 30 and exhaust filter 28 may be in the same canister, as shown, or separate. The DOC 30 is configured to oxidize Carbon Monoxide (CO) and unburnt hydrocarbons (HC) into Carbon Dioxide (CO2). The aftertreatment system 14 may also include a Selective Catalytic Reduction (SCR) system configured to reduce an amount of NOx in the exhaust stream 16 in the presence of a reductant. The aftertreatment system 14 may also include a Lean Nox Traps (LNTs) system configured to reduce an amount of NOx in the exhaust stream 16. The aftertreatment system 14 may also include an Ammonia Oxidation Catalyst (AMOX) system configured to reduce an amount of ammonia in the exhaust stream 16.

The aftertreatment system 14 may also include a heat source 32 to remove the soot from or regenerate the exhaust filter 28 or thermally manage the components of the aftertreatment system 14. The heat source 32 may embody a burner, hydrocarbon dosing system to create an exothermic reaction on the DOC 30, electric heating element, microwave device, or other heat source. The heat source 32 may also embody operating the engine 12 under conditions to generate elevated exhaust stream 16 temperatures. The heat source 32 may also embody a backpressure valve or another controllable restriction in the exhaust to cause elevated exhaust stream 16 temperatures.

The aftertreatment system 14 may include an exit pipe 34 connected to the outlet canister 26, delivering the exhaust stream 16 out of the aftertreatment device 20 to an exhaust stack or exhaust pipe 36. The outlet canister 26 may include a drain plug 38 installed in a drain plug port 40. The drain plug 38 may be used to remove water that has condensed or liquid that has otherwise collected in the aftertreatment device 20.

In the illustrated embodiment, the exhaust stream 16 exits the engine 12, passes by or through the heat source 32, passes through the aftertreatment device 20 (including the exhaust filter 28), then through the exit pipe 34 and out the exhaust pipe 36.

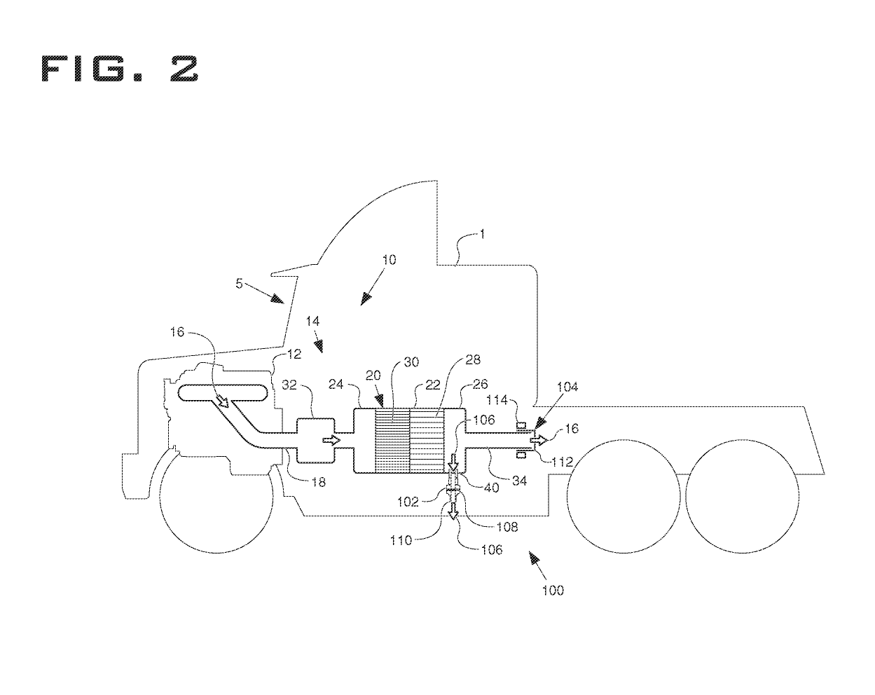

FIG. 2 shows the machine 1 in a test mode 5 and equipped with a test kit 100. The test kit 100 includes a collector 102 and a restrictor 104. The collector 102 is fluidly connected to the aftertreatment system 14 downstream of the exhaust filter 28. In the currently illustrated embodiment, the collector 102 is installed in the drain plug port 40 but could be in another port or anywhere else downstream of the exhaust filter 28.

The restrictor 104 is installed to create backpressure in the aftertreatment system 14 by restricting flow of the exhaust stream 16 downstream of the exhaust filter 28 and downstream of the collector 102. In the currently illustrated embodiment, the restrictor 104 is installed on the end of the exit pipe 34.

The collector 102 enables a test stream 106 of exhaust to be diverted or divided from the main exhaust stream 16. The test stream 106 passes through the collector 102 and may be small in comparison to the main exhaust stream 16. The backpressure created by the restrictor 104 assists in the creating of the test stream 106. Therefore, the restrictor 104 may be downstream from where the test stream 106 is diverted. The engine 12 speed may also be increased to a level that will provide the flow and backpressure needed to drive the amount of test stream 106 needed.

The collector 102 includes an indicator 108 and a housing 110. The test stream 106 passes through or past the indicator 108. The appearance, color, or shading of the indicator 108 in turn changes in response to the content of the test stream 106.

The housing 110 connects the collector 102 to the aftertreatment system 14, houses the indicator 108, and defines a flow path for the test stream 106 to pass through.

The restrictor 104 may include an orifice plate 112 and a connector 114. The orifice plate 112 effectively reduces the diameter or size of the conduit that the exhaust stream 16 passes through, creating the backpressure. The connector 114 connects the restrictor 104 to the aftertreatment system 14 and may embody a clamp or another securing method.

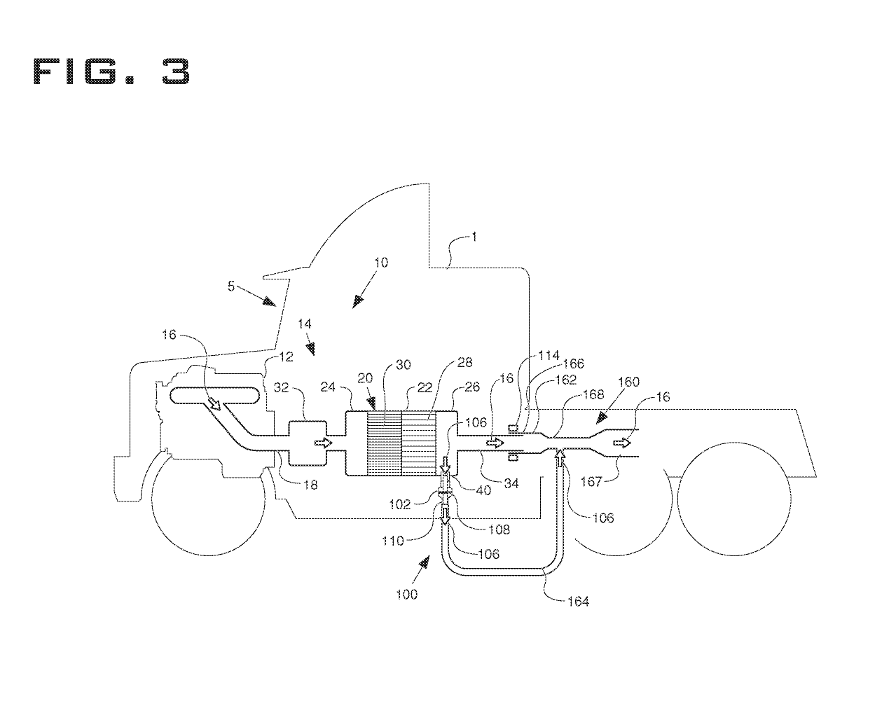

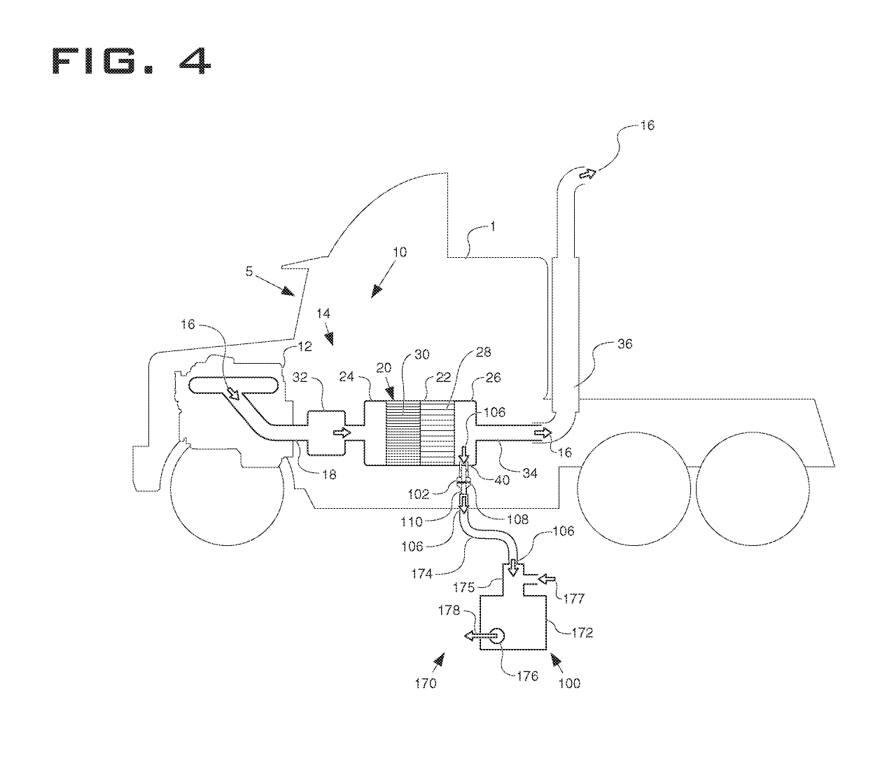

FIGS. 3 and 4 show alternative embodiments of the test kit 100, involving alternative ways of directing the directing the test stream 106 through the collector 102 via suction. These alternative embodiments may replace the restrictor 104 or may be used in addition to the restrictor 104.

FIG. 3 shows the test kit 100 may include a venturi system 160 to pull the test stream 106 through the collector 102. The venturi system 160 includes a venturi pipe 162 and a suction hose 164. The venturi pipe 162 includes an inlet end 166, an outlet end 167, and a neck down section 168 there between. The neck down section 168 necks down to have a smaller cross-sectional area compared to the inlet end 166 and outlet end 167, and the venturi pipe 162 may be connected to the exit pipe 34 with connector 114.

The venturi pipe 162 may only be installed while the machine 1 is in test mode 5. The venturi pipe 162 may also be attached to the end of exhaust pipe 36 or elsewhere downstream of the exhaust filter 28. The venturi pipe 162 could also be equipped permanently on the machine 1, during both operation and test mode 3, 5.

The suction hose 164 is fluidly connected at one end to the outlet of the collector 102 downstream of the indicator 108. The other end of the suction hose 164 is fluidly connected to the neck down section 168 of the venturi pipe 162. As the exhaust stream 16 passes through the neck down section 168, the exhaust stream 16 speeds up, causing a low pressure region. This low pressure region will pull the test stream 106 through the collector 102, through the suction hose 164, and into the venturi pipe 162.

FIG. 4 shows the test kit 100 may include a pump system 170 to pull the test stream 106 through the collector 102. The pump system 170 includes a pump 172 and a suction hose 174. The pump 172 includes an inlet manifold 175 and an outlet 176.

The suction hose 174 is fluidly connected at one end to the outlet of the collector 102 downstream of the indicator 108. The other end of the suction hose 174 is fluidly connected to the inlet manifold 175. The pump 172 has a motor and a suction pump that draws the test stream 106 through the collector 102, through the suction hose 174, and into the pump 172 through the inlet manifold 175.

Cooler ambient or fresh air 177 may also be drawn into the pump 172 through the inlet manifold 175 to mix with the test stream 106. This mixture 178 is the drawn through the pump 172 and passes out the outlet 176. The mixture 178 of fresh air 177 and the test stream 106 will be cooler than the test stream 106 alone, which may be needed if components of the pump 172 are not be able to withstand the high temperatures of the test stream 106.

The pump 172 may be electrically driven or powered by an operator or another source. The pump 172 may programmed to run for the desired test time or the ECM or another controller could power and control the pump 172 for the desired test time.

The indicator 108 may be a thin filter material, paper, or another media that the test stream 106 passes through and changes color or shading as a result of being exposed to particulate matter. In other embodiments, the test stream 106 may impact or pass over the indicator 108. In some embodiments the indicator 108 may be electrostatic tubing that becomes discolored when exposed to the test stream 106. The indicator 108 may be easily replaced and may require a new indicator 108 for each test.

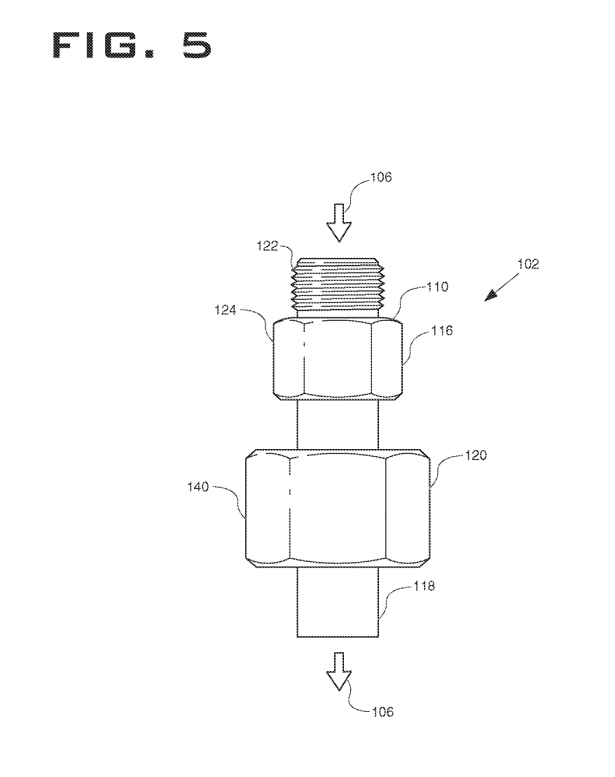

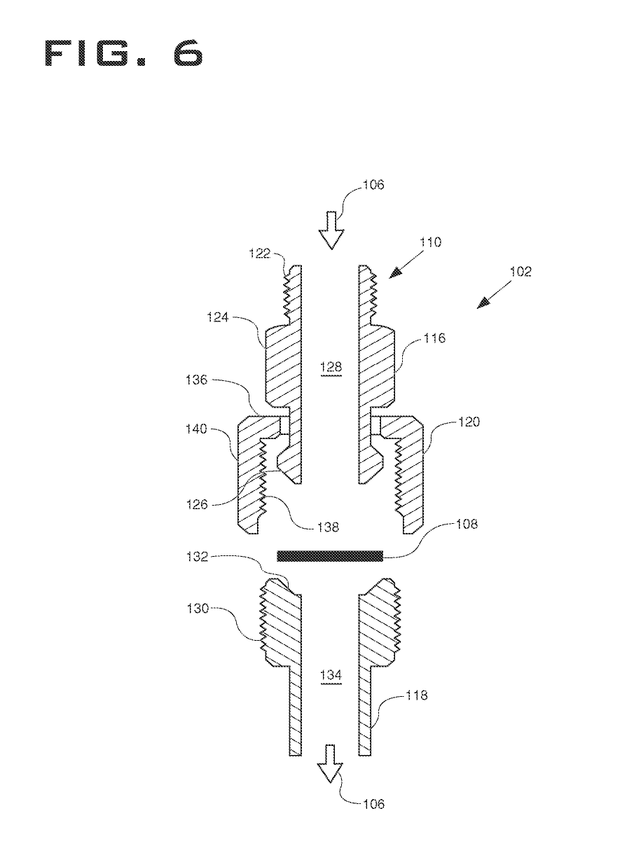

One embodiment of the collector 102 is shown in more detail in FIGS. 5 and 6. The housing 110 is shown to include an upstream end 116, downstream end 118, and a retaining collar 120. The upstream end 116 includes an upstream threaded portion 122, an upstream nut 124, an upstream flange 126, and an upstream passage 128. The upstream threaded portion 122 threads into the drain plug port 40, or otherwise connects to the aftertreatment system 14.

The downstream end 118 includes a downstream threaded portion 130, a downstream flange 132, and a downstream passage 134. The retaining collar 120 includes a retaining ledge 136, an inner threaded portion 138, and a collar nut 140. The indicator 108 is trapped between the upstream flange 126 and the downstream flange 132. The inner threaded portion 138 of the retaining collar 120 connects the retaining collar 120 to the downstream end 118. The retaining ledge 136 traps the upstream end 116 between the retaining collar 120 and downstream end 118. The upstream passage 128 and downstream passage 134 are aligned to form the flow path for the test stream 106.

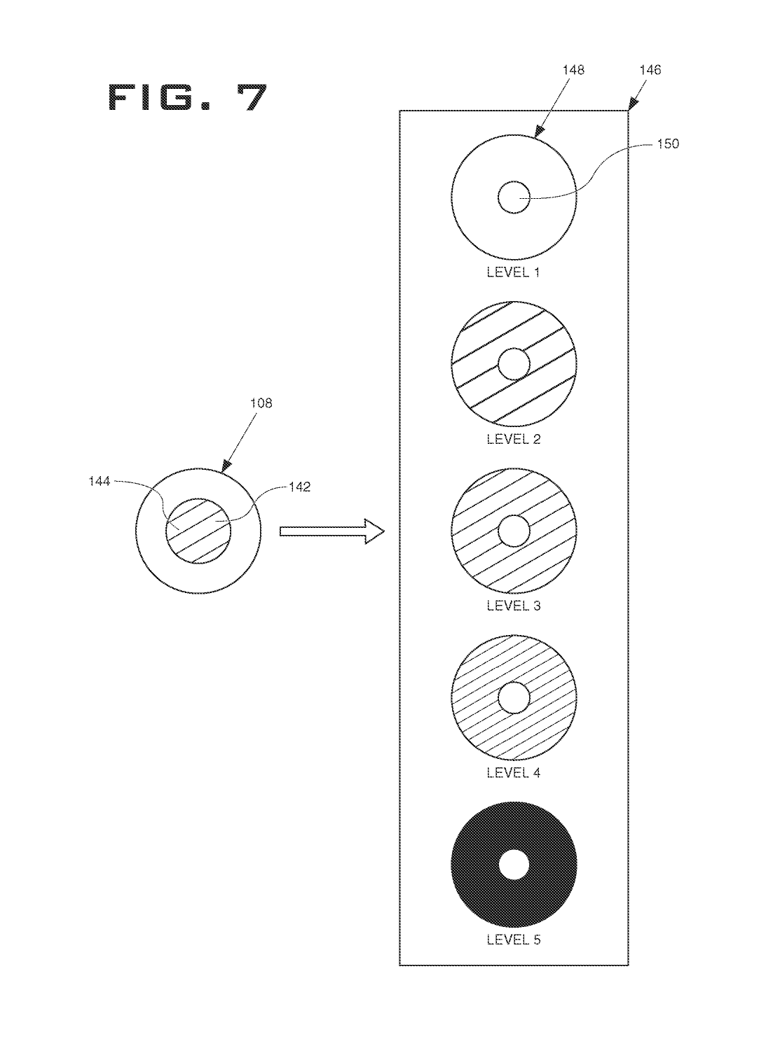

The test stream 106 enters through the upstream passage 128, passes through the indicator 108, and exits the collector 102 through the downstream passage 134. As seen in FIG. 7, the indicator 108 includes an exposed portion 142 where the indicator 108 is exposed to the test stream 106. Particulate matter in the test stream 106 causes a discoloration 144 in the exposed portion 142. This discoloration 144 may be a degree of shading from white to black or light to dark.

FIG. 7 also shows a grading sheet 146 that includes test samples 148. The test samples 148 correspond to levels of discolorations from light to dark. FIG. 7 shows five levels, but more or fewer may be used. The indicator 108 is assigned a level by comparing the discoloration 144 with the test samples 148. The test samples 148 may include an opening 150 so that the indicator 108 can be placed under the grading sheet 146 and the discoloration 144 can be visually compared side-by-side to the test samples 148. FIG. 7 illustrates graduating degrees of discoloration from light to dark using lines and shading.

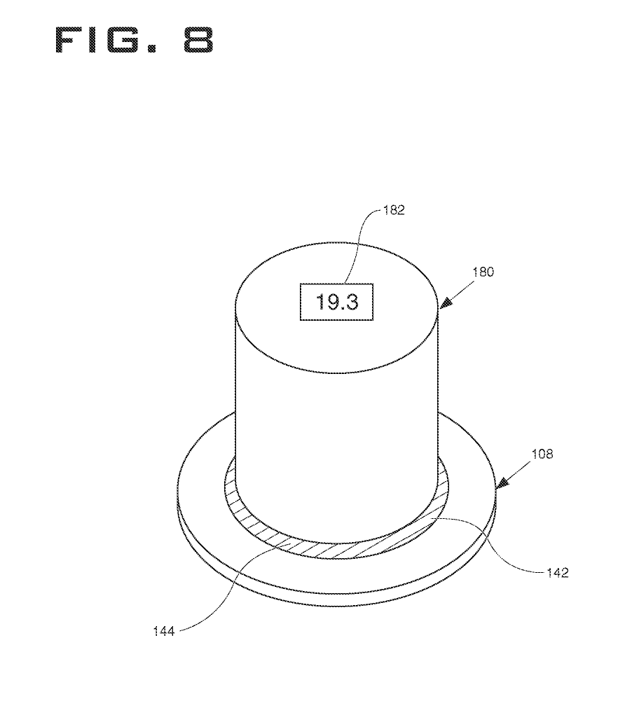

FIG. 8 shows a meter 180 that may be used as a digital alternative to the grading sheet 146. The meter 180 is a device capable of measuring the reflectance of light or light transmittance or another aspect of the discoloration 144. The meter 180 may also be able to quantify the discoloration with a digital reading 182. The reading 182 could then be assigned to a level using a scale of readings with ranges corresponding to different levels.

The meter 180 may be portable or a desktop unit and may be battery or hard wired. One example of a device that may be suited for or adapted for use as meter 180 is window tint meters. These window tint meters are used to measure the darkness of window tint by measuring the percentage of light transmitted through the window glass.

### INDUSTRIAL APPLICABILITY

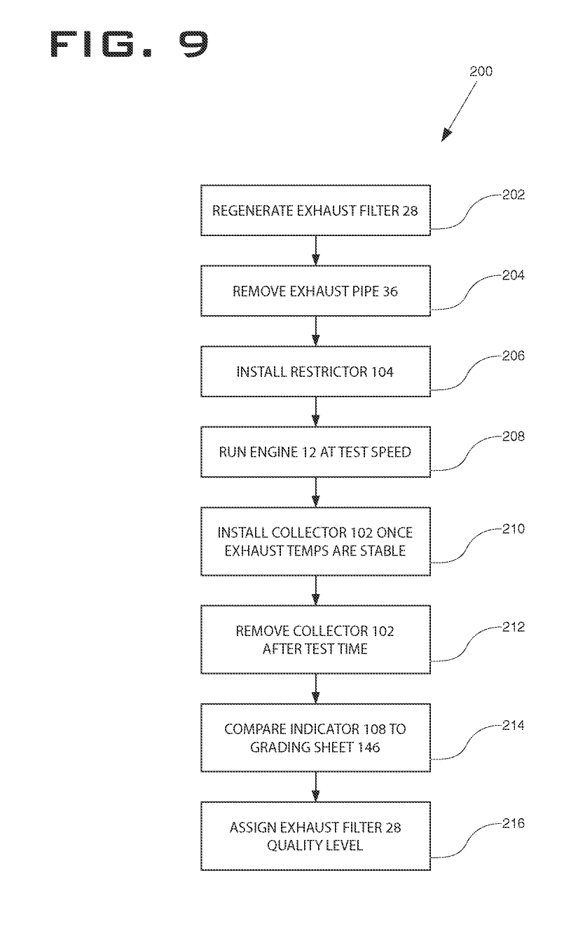

FIG. 9 illustrates a test method 200 using the test kit 100. First, in step 202 the exhaust filter 28 is regenerated by removing collected particulate matter. This regeneration may be achieved by manually forcing the power system 10 to enter into a regeneration cycle, activation the heat source 32, or applying an external heat source to the exhaust filter 28. This regeneration may require the engine 12 to be ran at a desired speed, such as high idle.

In other embodiments, the test method 200 may not require a regeneration of the exhaust filter 28 beforehand. Once a soot cake has been deposited inside the exhaust filter 28 filter efficiency may not significantly change with changing levels of soot. Therefore, the amount of soot may not have to be considered and the regeneration may not be necessary to the test method 200.

Next, in step 204, the exhaust pipe 36 is removed. An operator may need to wait for the power system 10 to cool down after step 202 before removing the exhaust pipe 36. In step 206 the restrictor 104 is installed on to the end of the exit pipe 34. Steps 204 and 206 may be adapted as needed to accommodate the alternative embodiments of the test kit 100 shown in FIGS. 3 and 4.

In step 208 the engine 12 is ran at high idle or at a predetermined engine test speed for long enough to stabilize the exhaust temperatures, which may take a minimum of 10 minutes. In step 210 the collector 102 is installed. The installation of the collector may be done after shutting the engine 12 off, but should be done quickly enough so that temperatures do not drop significantly.

Next, in step 212 the test is conducted. During the test, the engine is run for a predetermined test time at the predetermined engine test speed. Regeneration of the exhaust filter 28 may be disabled during the test. In one embodiment, the test time may be 20 minutes and the engine test speed may correspond to high idle, but many other test times and engine test speeds could be used so long as the grading sheet 146 was recalibrated accordingly. The test time and engine test speed may be selected to achieve the desired amount and rate of flow through the collector 102. The predetermined engine test speed may be constant or varied over the test time in a controlled manner. After the predetermined test time, the collector 102 is removed or the engine 12 is shut down after the test time has elapsed. An operator may need to wait for the aftertreatment system 14 to cool after the engine 12 is shut down before removing the collector 102.

Performance of the preceding steps of the test method 200 may be assisted or aided by a test routine in the engine's 12 electronic control module (ECM). This test routine would control the engine's 12 operation according to the parameters required by the test method 200 and may reduce the chances of error by an operator or technician.

In step 214 the indicator 108 is removed from the collector 102 and the discoloration 144 is compared to the grading sheet 146. The collector 102 may have to be disassembled to remove the indicator 108. Next, in step 216 an exhaust filter quality level is assigned based on the comparison from step 214. Steps 214 and 216 may be adapted to account for use the alternate meter 180 for assigning the exhaust filter quality level.

Based on this quality level, a decision can be made regarding further actions. For instance, if the discoloration 144 is too much and assigned level too high, the exhaust filter 28 may be replaced. The order of some of the steps described above may be rearranged while still achieving the desired result.

The exhaust filter 28 quality level may relate to a degree of cracking that has occurred in the exhaust filter 28 during operation. This cracking may be a result of stress and weakening of the material from excessive temperature spikes, fast temperature swings causing thermal shocks, vibration causing cyclical failures, or large mechanical impacts. The exhaust filter 28 quality may also relate to other degradations to the exhaust filter 28 that would allow particulate matter to pass through the exhaust filter 28 in higher than anticipated amounts.

When the exhaust filter 28 is cracked, particulate matter passes through without being collected in the anticipated amounts. The test method 200 described above detects this excess particulate matter based on the amount of discoloration 144 on the indicator 108. The more particulate matter that makes it past the exhaust filter 28, the more particulate matter that will be in the test stream 106, and the more particulate matter that will be deposited on the exposed portion 142 of the indicator 108, and the darker the shading or discoloration 144 will be.

The test kit 100 and test method 200 described above allow the exhaust filter 28 to be tested while still installed on the machine 1. Other tests require the exhaust filter 28 to be removed and often sent away for evaluation, which is time consuming and expensive. The test method 200 is also quick and easy for an operator to perform. The backpressure created by the restrictor 104 helps achieve results in a reduced amount of time. The predetermined test times and engine test speeds may help provide accurate, comparable, and repeatable results in the field.

The test kit 100 is also inexpensive. The test kit 100 may require no electronics or moving parts. In contrast, other sensors used for these types of tests can be expensive, making them impractical for widespread use. Because of the small test stream 106 of exhaust, the collector 102 may be smaller in size than would otherwise be needed. Because the drain plug port 40 may be used to install the collector 102, modifications to the machine 1 are minimal to conduct the test. Despite the quick test time and inexpensive hardware, the test method 200 provides a quantifiable indication of the exhaust filter 28 quality or effectiveness. Because of these features, the test kit 100 and test method 200 may be particularly suited for mobile machines 1, which may require inexpensive hardware, on-machine testing, and fast test times as a large number of field tests may be required.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A method for determining the effectiveness of an exhaust filter comprising:
exposing an indicator to an exhaust stream of a engine downstream of the exhaust filter;
visually comparing the indicator against test samples; and
assigning a level of exhaust filter effectiveness based on the comparison.

2. The method of claim 1 further including:
diverting a test stream of exhaust from the exhaust stream and exposing the indicator to the test stream.

3. The method of claim 2 further including:
restricting the exhaust stream downstream of where the test stream is diverted.

4. The method of claim 3 wherein the test stream is diverted through a collector connected to an outlet can adjacent to an outlet of the exhaust filter.

5. The method of claim 4 wherein the collector is connected into a drain plug port in the outlet can.

6. The method of claim 4 wherein the indicator is housed inside the collector.

7. The method of claim 1 wherein the indicator is exposed to the test stream for a predetermined amount of time and at a predetermined engine speed.

8. The method of claim 7 further including:
regenerating the exhaust filter before exposing the indicator to the exhaust stream.

9. The method of claim 1 conducted while the exhaust filter is installed on a mobile machine.

10. A method for determining the effectiveness of an exhaust filter while installed on a mobile machine comprising:
restricting an exhaust stream of a engine downstream of the exhaust filter;
diverting a test stream of exhaust from the exhaust stream; and
exposing an indicator to the test stream downstream of the exhaust filter.

11. The method of claim 10 further including:
visually comparing the indicator against test samples; and
assigning a level of exhaust filter effectiveness based on the comparison.

12. The method of claim 10 wherein the test stream is diverted through a collector connected to an outlet can adjacent to an outlet of the exhaust filter.

13. The method of claim 12 wherein the collector is connected into a drain plug port in the outlet can.

14. The method of claim 13 wherein the indicator is housed inside the collector.

15. The method of claim 10 wherein the indicator is exposed to the test stream for a predetermined amount of time and at a predetermined engine speed.

16. The method of claim 10 further including:
regenerating the exhaust filter before exposing the indicator to the exhaust stream.

17. A kit for determining the effectiveness of an exhaust filter while installed on a mobile machine comprising:
a collector including a housing defining a flow passage configured to transmit a test stream of exhaust from a engine; and
a restrictor including a orifice plate configured to restrict an exhaust stream from which the test stream is diverted.

18. The kit of claim 17 wherein the collector is configured to house and expose an indicator to the test stream.

19. The kit of claim 18 wherein the indicator includes a filter media configured to allow the test stream to pass through and change appearance in response to an amount of particulate matter the filter media is exposed to.

20. The kit of claim 19 further including:
a grading sheet including test samples to compare the filter media against and assign a level of exhaust filter effectiveness based on the comparison.
